(19) United States
(12) Patent Application Publication
(10) Pub. No.: US 2025/0121580 A1
(43) Pub. Date: Apr. 17, 2025

(54) PANEL MEMBER, PANEL MEMBER MANUFACTURING METHOD, AND PANEL MEMBER MANUFACTURING APPARATUS

(71) Applicant: Shinmaywa Industries, Ltd., Takarazuka-shi (JP)

(72) Inventors: Tomohiro KAMACHI, Takarazuka-shi (JP); Taiichi NISHIMURA, Takarazuka-shi (JP); Ryota TERAYAMA, Takarazuka-shi (JP)

(21) Appl. No.: 19/003,073

(22) Filed: Dec. 27, 2024

Related U.S. Application Data
(63) Continuation of application No. PCT/JP2023/012434, filed on Mar. 28, 2023.

(30) Foreign Application Priority Data
Jun. 29, 2022 (JP) 2022-104159
Aug. 3, 2022 (JP) 2022-123855

(51) Int. Cl. B32B 5/12; B32B 3/28; B32B 27/08

(52) U.S. Cl. CPC B32B 5/12; B32B 3/28; B32B 27/08; B32B 2250/03; B32B 2250/24; B32B 2250/40; B32B 2262/106; B32B 2605/18

(57) ABSTRACT

A panel includes first and second skins each including thermoplastic resin, and an intermediate portion including continuous fibers. The first skin includes a first connection region connected to the intermediate portion, and a first non-connection region. The second skin includes a second connection region connected to the intermediate portion, and a second non-connection region. The first connection region and the first non-connection region are arranged alternately in a first direction X. The second connection region and the second non-connection region are arranged alternately in the first direction X. A dimension of the first non-connection region in the first direction X differs from a dimension of the second non-connection region in the first direction X.

### CROSS REFERENCE TO RELATED APPLICATIONS

This application claims the benefit of priority to Japanese Patent Application No. 2022-104159 filed on Jun. 29, 2022 and Japanese Patent Application No. 2022-123855 filed on Aug. 3, 2022 and is a Continuation Application of PCT Application No. PCT/JP2023/012434 filed on Mar. 28, 2023. The entire contents of each application are hereby incorporated herein by reference.

### BACKGROUND OF THE INVENTION

### 1. Field of the Invention

The present invention relates to panels each including skins including thermoplastic resin and an intermediate portion including continuous fibers, methods for manufacturing the panels, and apparatuses for manufacturing the panels.

### 2. Description of the Related Art

Panels known in the art each include sheet-shaped outer layer bodies (i.e., skins) and a low-density intermediate portion, such as a honeycomb, polymeric foam, or corrugated intermediate portion, which is interposed between the skins. Such panels exhibit high strength and rigidity. Such panels are thus used in various fields and for various purposes, including use as airframe components of airplanes.

A panel including a corrugated intermediate portion, for example, is higher in bending strength than a panel including a honeycomb intermediate portion. When such a panel includes thermoplastic resin, the panel is able to undergo secondary forming by application of heat thereto and is thus advantageous in being formed into a shape suitable for its use. A technique that has been known in recent years involves devising a way of arranging continuous fibers so as to enhance mechanical strength in accordance with the shape of a structure (see, for example, JP 2019-130695 A).

### SUMMARY OF THE INVENTION

A panel including thermoplastic resin and an intermediate portion including continuous fibers as described above is expected to be lighter in weight and higher in mechanical strength in order for the panel to find use in a wider range of applications and demonstrate greater versatility. Accordingly, the inventors have focused attention on an arrangement that is able to achieve both of these two goals at the same time in the course of conducting extensive studies.

Reducing a region occupied by an intermediate portion in a panel, for example, enables the panel to be lighter in weight. Reducing the region occupied by the intermediate portion, however, makes the panel susceptible to a reduction in strength. In particular, when regions of skins connected to the intermediate portion are reduced (i.e., when non-connection regions are increased), strength to withstand an impact from outside may decrease. This presents difficulty in achieving lighter weight and enhanced strength.

Example embodiments of the present invention provide panels each of which is light in weight and has high strength to withstand an impact from outside. Example embodiments of the present invention also provide manufacturing methods and manufacturing apparatuses that are able to successfully manufacture such panels.

A panel disclosed herein includes a first skin and a second skin each including thermoplastic resin and having a sheet shape, and an intermediate portion including continuous fibers and interposed between the first skin and the second skin. The first skin includes a first connection region connected to the intermediate portion, and a first non-connection region not connected to the intermediate portion. The second skin includes a second connection region connected to the intermediate portion, and a second non-connection region not connected to the intermediate portion. The first connection region and the first non-connection region are arranged alternately in a first direction. The second connection region and the second non-connection region are arranged alternately in the first direction. A dimension of the first non-connection region in the first direction differs from a dimension of the second non-connection region in the first direction.

The first skin and the second skin include the non-connection regions not connected to the intermediate portion, with the result that the panel is provided with vacant regions and is thus reduced in weight. Making a proportion occupied by the non-connection regions larger than before, for example, makes it possible to further promote weight reduction. Because the first non-connection region and the second non-connection region differ in dimension, the connection region (i.e., the first connection region) of the first skin and the connection region (i.e., the second connection region) of the second skin differ in dimension. Placing one of the first and second skins having a larger connection region, in an area susceptible to an impact, makes it possible to effectively disperse or absorb the impact and achieve high durability.

When the panel is used as a floor surface of a structure, the first skin may be an upper skin above the intermediate portion, and the second skin may be a lower skin below the intermediate portion. In this case, the dimension of the first non-connection region in the first direction is preferably smaller than the dimension of the second non-connection region in the first direction. This results in an increase in dimension of the connection region of the first skin (i.e., a proportion occupied by the connection region). The first skin is able to exhibit high compressive strength to withstand, for example, bending strength (which compresses the upper skin and stretches the lower skin) applied when a person steps on flooring.

Devising an orientation structure of the continuous fibers makes it possible to further enhance the strength of the panel.

A dimension of the first connection region in a second direction perpendicular to the first direction, for example, may be larger than a dimension of the first connection region in the first direction. A dimension of the first non-connection region in the second direction may be larger than the dimension of the first non-connection region in the first direction. A dimension of the second connection region in the second direction may be larger than a dimension of the second connection region in the first direction. A dimension of the second non-connection region in the second direction may be larger than the dimension of the second non-connection region in the first direction. The continuous fibers included in the intermediate portion may include first intermediate continuous fibers extending in the first direction. Thus, the connection region and the non-connection region of the first skin are arranged alternately in the first direction, the connection region and the non-connection region of the second skin are arranged alternately in the first direction, the second direction corresponds to a longitudinal direction of the connection and non-connection regions, and the first direction corresponds to a longitudinal direction of the continuous fibers in the intermediate portion. This makes it possible to enhance the strength of the panel to withstand out-of-plane compression (i.e., pressing force that will crush the intermediate portion).

The continuous fibers included in the intermediate portion may further include second intermediate continuous fibers extending in a direction intersecting the first direction. The first intermediate continuous fibers may be in an area of the intermediate portion located between the first skin and the second intermediate continuous fibers and adjacent to the first skin. This enables the intermediate portion to have, at its outer area, strength to withstand out-of-plane compression described above. Areas of the intermediate portion that change from areas connected to the first skin to areas (i.e., non-connection areas) not connected to the first skin (which are, for example, corner portions of the intermediate area when it has a corrugated shape) are reinforced so as to facilitate maintaining the shape of the intermediate portion. Consequently, the panel is able to exhibit enhanced strength to withstand out-of-plane compression.

The first skin may include first skin continuous fibers extending in the first direction, and second skin continuous fibers extending in a direction intersecting the first direction. The first skin continuous fibers may be in an area of the first skin located opposite to the intermediate portion. The second skin continuous fibers may be between the first skin continuous fibers and the intermediate portion. The first skin thus has, at its outer area, strength to withstand out-of-plane compression described above. This produces particularly remarkable effects on local stress applied to the first skin.

The above-described panel may include any of intermediate portions of various shapes. A cross-sectional shape of the intermediate portion orthogonal to a second direction perpendicular to the first direction may be a corrugated shape. Increasing the connection regions of the skins provides a structure resistant to stress applied to the skins from outside. Reducing a corrugate cycle (i.e., the number of pitches) by relatively increasing the connection regions enables weight reduction.

The intermediate portion may include sub-portions arranged in the first direction and separated from each other in the first direction. A cross-sectional shape of each of the sub-portions orthogonal to a second direction perpendicular to the first direction may be a hat shape. This shape also makes it possible to achieve effects equivalent to those achieved by the corrugated cross-sectional shape. The hat shape makes the non-connection region of one of the skins larger than in the corrugated cross-sectional shape, and thus enables further weight reduction.

A panel manufacturing method disclosed herein is a method for manufacturing a panel by connecting a continuous fiber-including intermediate portion to a first skin and a second skin each including thermoplastic resin and having a sheet shape. The intermediate portion is between the first skin and the second skin. The intermediate portion is provided with vacant regions defined by recesses and protrusions arranged in the first direction and extending in a second direction perpendicular to the first direction. The manufacturing method includes a recess and protrusion heating step for performing a heating process on the recesses and the protrusions of the intermediate portion, a skin placing step for placing the first skin on a first side in a third direction relative to the intermediate portion, and placing the second skin on a second side in the third direction relative to the intermediate portion, the third direction being perpendicular to the first direction and the second direction, and a skin connecting step for, after the skin placing step, connecting the first skin to the protrusions and connecting the second skin to the recesses.

The recess and protrusion heating step may include an abutment placing sub-step for placing abutments in the vacant regions and bringing the abutments into abutting contact with the intermediate portion, and an abutment heating sub-step for heating the abutments. Using this manufacturing method makes it possible to perform the process of connecting the first skin and the intermediate portion and connecting the second skin and the intermediate portion while keeping the abutments in abutment with the intermediate portion. Skillfully controlling the heating process on the abutments makes it possible to perform the connecting process while maintaining suitable temperature conditions, which leads to stabilization of product quality.

The skin placing step may include a skin supporting sub-step for supporting the first skin with a first support, and a skin stretching sub-step for applying a tensile load to the first skin in the first direction. The skin placing step may include a skin supporting sub-step for supporting the second skin with a second support, and a skin stretching sub-step for applying a tensile load to the second skin in the first direction. The manufacturing method is able to place the skins under predetermined tension and appropriately connect the regions of the skins. Accordingly, a failure, such as a connection failure, is avoidable, with the result that the panel of high quality is manufacturable.

The skin connecting step may include continuing to heat the abutments after the abutment heating sub-step. This makes it possible to prevent an excessive decrease in temperature caused by heat dissipation and avoid a failure, such as a connection failure.

The skin connecting step may include an abutment restraining sub-step for applying a restraining load to the abutments to prevent expansion of the abutments in the first direction. Thus, deformation of the abutments caused by a load applied during the connecting process, for example, is preventable. Unnecessary deformation of the intermediate portion is preventable, with the result that the quality of the panel is maintainable. The phrase “applying a restraining load” may be adequately used herein to refer to a situation in which when the abutments are expanding, a restraining load is resultantly applied to the abutments. Accordingly, a where situation the abutments are under predetermined restraint will suffice.

The manufacturing method may include an intermediate portion providing step for providing the intermediate portion. The intermediate portion providing step may include a forming sub-step for forming the intermediate portion such that either the recesses or the protrusions have shapes whose dimensions in the first direction gradually decrease in the second direction, and the others of the recesses and the protrusions have shapes whose dimensions in the first direction gradually increase in the second direction. The skin connecting step may include a pressing and cooling sub-step for cooling the first skin, the second skin, and the intermediate portion, and an abutment removing sub-step for removing the abutments from the vacant in the first direction.

The recess and protrusion heating step may include an abutment placing sub-step for placing abutments in the vacant regions and bringing the abutments into abutting contact with the intermediate portion. The skin connecting step may include a pressing and connecting sub-step for connecting the first skin to the protrusions while pressing the first skin thereto, and connecting the second skin to the recesses while pressing the second skin thereto. The pressing and connecting sub-step may be performed after the abutment placing sub-step. The manufacturing method involves pressing the skins against the intermediate portion, with the abutments located in the vacant regions, and is thus able to press the non-connection regions of the skins against the abutments similarly to the connection regions of the skins to be connected to the intermediate portion. Accordingly, the skins are pressed substantially uniformly, resulting in the panel of high quality.

The skin connecting step may include a pressing and connecting sub-step for, with a press, connecting the first skin to the protrusions while pressing the first skin thereto and/or connecting the second skin to the recesses while pressing the second skin thereto, and a pressing and cooling sub-step for cooling the press. The manufacturing method involves continuing the pressing process also during the cooling process in consideration of influences on the connecting process. This makes it possible to sufficiently achieve elaborate effects, including a pressure feedback action. In the event of sudden temperature rise and drop, in particular, unexpected influences of such temperature changes are considerably reducible.

In addition to the above, the recess and protrusion heating step may include an abutment placing sub-step for placing abutments in the vacant regions and bringing the abutments into abutting contact with the intermediate portion, and an abutment heating sub-step for heating the abutments.

The skin connecting step may include a heater placing sub-step for placing a heater between the first skin and the intermediate portion so as to heat the first skin and the intermediate portion with the heater, and/or placing a heater between the second skin and the intermediate portion so as to heat the second skin and the intermediate portion with the heater.

A panel manufacturing apparatus disclosed herein is a manufacturing apparatus for manufacturing a panel by connecting a continuous fiber-including intermediate portion to a first skin and a second skin each including thermoplastic resin and having a sheet shape. The intermediate portion is between the first skin and the second skin, and includes vacant regions defined by recesses and protrusions arranged in the first direction and extending in a second direction perpendicular to the first direction. The manufacturing apparatus includes a first mold to place the first skin on a first side in a third direction relative to the intermediate portion and support the first skin such that the first skin is movable toward a second side in the third direction, the third direction being perpendicular to the first direction and the second direction, a second mold to place the second skin on the second side in the third direction relative to the intermediate portion and support the second skin such that the second skin is movable toward the first side in the third direction, abutments to be placed in the vacant regions of the intermediate portion and brought into abutting contact with the recesses and the protrusions, and a restraint to restrain movement of the abutments in the first direction.

Example embodiments of the present invention are able to provide panels each of which is light in weight and has high strength to withstand an impact from outside. Example embodiments of the present invention are also able to provide manufacturing methods and manufacturing apparatuses that are capable of successfully manufacturing such panels.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a schematic perspective view of a panel according to a first example embodiment of the present invention, which is placed on supporting rails.

FIG. 1B is a schematic cross-sectional view of the panel taken along an X-Z plane of FIG. 1A.

FIG. 2A is a schematic perspective view illustrating a longitudinal direction of continuous fibers in an outermost layer included in an upper skin of the panel according to the first example embodiment of the present invention.

FIG. 2B is a schematic perspective view illustrating a longitudinal direction of continuous fibers in an outermost layer included in an intermediate portion of the panel.

FIGS. 3A to 3C are schematic cross-sectional views illustrating structures and effects of the panel according to the first example embodiment of the present invention.

FIGS. 4A to 4D are schematic cross-sectional views of the panel according to the first example embodiment of the present invention, which is secured to the supporting rails.

FIG. 5A is a schematic cross-sectional view illustrating a structure of a panel according to a second example embodiment of the present invention.

FIG. 5B is a schematic cross-sectional view illustrating a structure of a panel according to a third example embodiment of the present invention.

FIG. 6 is a schematic perspective view of a panel according to a fourth example embodiment of the present invention, which is placed on supporting rails.

FIG. 7 is a flow chart illustrating steps included in a panel manufacturing method.

FIG. 8A is a schematic cross-sectional view of the panel, illustrating a recess and protrusion heating step.

FIG. 8B is a schematic cross-sectional view of the panel, illustrating a skin placing step.

FIGS. 9A to 9C are schematic cross-sectional views of the panel, illustrating a skin connecting step.

FIG. 10 is a schematic perspective view illustrating a panel according to an alternative example embodiment of the present invention and a method for manufacturing the panel.

### DETAILED DESCRIPTION OF THE EXAMPLE EMBODIMENTS

With reference to the drawings, example embodiments of panels, panel manufacturing methods, and panel manufacturing apparatuses will be described. The following description first discusses example embodiments of panels and then discusses example embodiments of panel manufacturing methods and manufacturing apparatuses.

Unless otherwise specified, the term “X direction” as used in the following description subsumes an X direction illustrated in the drawings and a direction opposite thereto. Similarly, the term “Y direction” subsumes a Y direction illustrated in the drawings and a direction opposite thereto, and the term “Z direction” subsumes a Z direction illustrated in the drawings and a direction opposite thereto. The term “correspond” subsumes not only a strict correspondence but also an approximate correspondence.

### First Example Embodiment of Panel

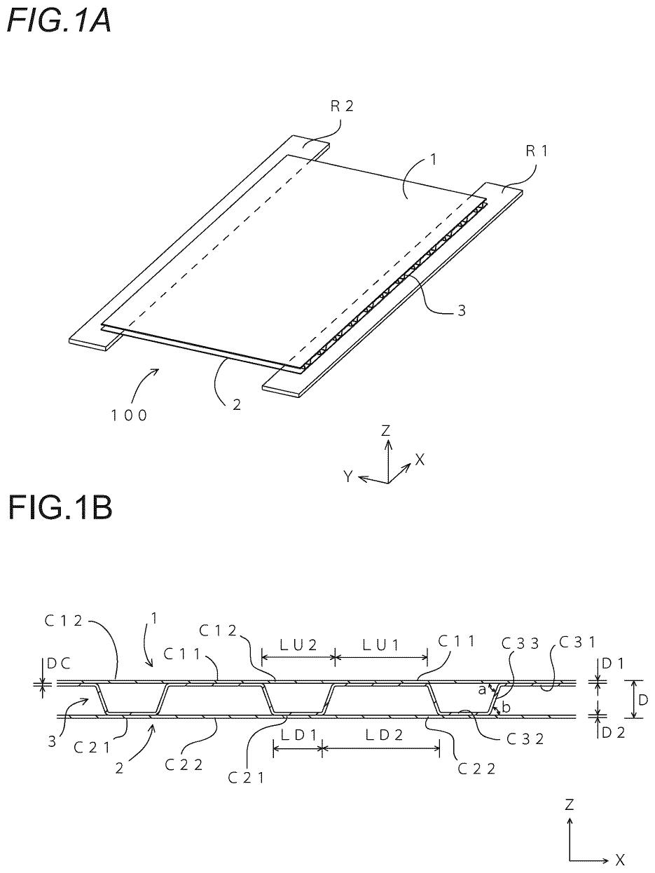

FIG. 1A is a schematic perspective view of a panel 100 according to a first example embodiment. The panel 100 includes a first skin 1 and a second skin 2 each including thermoplastic resin and having a sheet shape, and an intermediate portion 3 including continuous fibers and interposed between the first skin 1 and the second skin 2. First and second ends of the panel 100 in the Y direction are each supported by an associated one of supporting rails R1 and R2 extending in the X direction. The panel 100 is thus installed in the form of flooring.

In the present example embodiment, the first skin 1 is above the intermediate portion 3. The first skin 1 is used as an upper skin of the panel 100. The first skin 1 is a carbon fiber reinforced composite provided by blending carbon fibers (e.g., PAN carbon fibers) into thermoplastic resin (e.g., polyphenylene sulfide or ketonic resin). Similarly, the second skin 2 is a carbon fiber reinforced composite provided by blending carbon fibers into thermoplastic resin. The intermediate portion 3 is made of a corrugated material including recesses and protrusions arranged alternately in the X direction. The recesses and the protrusions are continuous with each other in the X direction and are thus integral with each other. The recesses and the protrusions each extend in the Y direction. Similarly to the skins 1 and 2, the intermediate portion 3 is a carbon fiber reinforced composite provided by blending carbon fibers into thermoplastic resin. The panel 100 includes the composites described above and thus exhibits light weight and high strength and rigidity. The panel 100 includes carbon fibers and thus exhibits high flame resistance.

The shape and other features of the panel 100 will be described with reference to FIG. 1B. FIG. 1B is a schematic cross-sectional view of the panel 100 taken along an X-Z plane of FIG. 1A. In other words, FIG. 1B is a schematic cross-sectional view of the panel 100 taken in a direction orthogonal to the Y direction. For the sake of convenience of description, the supporting rails R1 and R2 are not illustrated in FIG. 1B.

The first skin 1 includes connection regions C11 connected to the intermediate portion 3, and non-connection regions C12 separated from the intermediate portion 3 and not connected to the intermediate portion 3. The connection regions C11 and the non-connection regions C12 are arranged alternately in the X direction and continuous with each other. A length of each connection region C11 in the X direction is represented as LU1, and a length of each non-connection region C12 in the X direction is represented as LU2. The length LU1 is longer than the length LU2. The connection regions C11 are larger than the non-connection regions C12 in the X direction. A thickness D1 of the first skin 1 is substantially uniform. Although the thickness D1 is 0.8 mm in this example embodiment, the thickness D1 may be of any other size. The thickness D1 may be suitably changed, for example, in the range of between about 0.4 mm and about 1.2 mm.

The second skin 2 includes connection regions C21 connected to the intermediate portion 3, and non-connection regions C22 separated from the intermediate portion 3 and not connected to the intermediate portion 3. The connection regions C21 and the non-connection regions C22 are arranged alternately in the X direction and continuous with each other. A length of each connection region C21 in the X direction is represented as LD1, and a length of each non-connection region C22 in the X direction is represented as LD2. The length LD2 is longer than the length LD1. The non-connection regions C22 are larger than the connection regions C21 in the X direction. The length LD2 of each non-connection region C22 differs from the length LU2 of each non-connection region C12 of the first skin 1. In the present example embodiment, the length LD2 of each non-connection region C22 of the second skin 2 is longer than the length LU2 of each non-connection region C12 of the first skin 1. A thickness D2 of the second skin 2 is substantially uniform. Although the thickness D2 is 0.6 mm in this example embodiment, the thickness D2 may be of any other size. The thickness D2 may be suitably changed, for example, in the range of between about 0.4 mm and about 1.2 mm.

The intermediate portion 3 includes upper surface portions C31 connected to the connection regions C11 of the first skin 1, lower surface portions C32 connected to the connection regions C21 of the second skin 2, and connectors C33 connecting the upper surface portions C31 to the lower surface portions C32. The upper surface portions C31 are thermally welded to the connection regions C11 of the first skin 1. The lower surface portions C32 are thermally welded to the connection regions C21 of the second skin 2. The upper surface portions C31, the connectors C33, and the lower surface portions C32 are integral with each other. The intermediate portion 3 has a corrugated cross-sectional shape in which the upper surface portions C31, the connectors C33, and the lower surface portions C32 are continuous and integral with each other in the X direction. A cross-sectional shape of the intermediate portion 3 orthogonal to the Y direction is corrugated. The intermediate portion 3 has such a corrugated cross-sectional shape and is thus provided with vacant regions V1 and V2. The intermediate portion 3 has a shape formed by extending the cross-sectional shape in the Y direction. As previously described, the connection regions C11 and the connection regions C21 differ in size from each other, with the result that the upper surface portions C31 are larger than the lower surface portions C32. An inclination angle a of each connector C33 with respect to the first skin 1 and an inclination angle b of each connector C33 with respect to the second skin 2 are each set at 70 degrees. The inclination angles a and b are required to be in the range of between 45 degrees and 90 degrees, and are particularly preferably in the range of about 60 degrees and about 75 degrees. In the present example embodiment, the panel 100 has a thickness D of 10 mm.

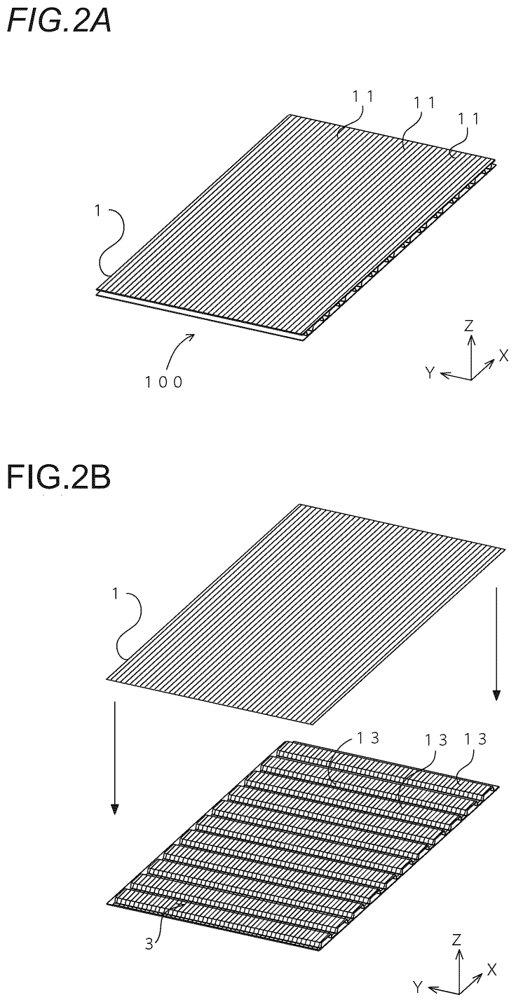

Referring to FIGS. 2A and 2B, orientations of carbon fibers (i.e., continuous fibers) in the panel 100 will be described below. In FIGS. 2A and 2B, carbon fibers are illustrated as being included in the schematic perspective view of FIG. 1A for the sake of convenience of description.

The first skin 1 includes four layers in the Z direction. Carbon fibers 11 are included in each of these layers. Directions of the carbon fibers 11 are 0 degrees, 90 degrees, 90 degrees, and 0 degrees in this order from bottom to top. The directions of the carbon fibers are represented as angles with respect to the X direction. In the first skin 1, the carbon fibers 11 have a biaxial orientation. As illustrated in FIG. 2A, an uppermost layer of the first skin 1 serving as an upper skin is provided with the carbon fibers 11 extending in the X direction. In the uppermost layer of the first skin 1, the X direction corresponds to a longitudinal direction of the carbon fibers 11. In this example embodiment, the content of the carbon fibers 11 in the first skin 1 is 60 percent by mass. The content of the carbon fibers 11 in the first skin 1, however, may be suitably changed, for example, in the range of between 40 percent by mass and 70 percent by mass, and is particularly preferably in the range of between 55 percent by mass and 70 percent by mass.

The second skin 2 serving as a lower skin includes three layers in the Z direction. The carbon fibers 11 are included in each of these layers. Directions of the carbon fibers are 90 degrees, 0 degrees, and 90 degrees in this order from bottom to top. In the second skin 2, the carbon fibers 11 have a biaxial orientation. Although not illustrated, the Y direction corresponds to the longitudinal direction of the carbon fibers 11 in an uppermost layer (i.e., an uppermost area) of the second skin 2 unlike in the uppermost layer of the first skin 1. In this example embodiment, the content of the carbon fibers 11 in the second skin 2 is 60 percent by mass. The content of the carbon fibers 11 in the second skin 2, however, may be suitably changed, for example, in the range of between 40 percent by mass and 70 percent by mass, and is particularly preferably in the range of between 55 percent by mass and 70 percent by mass.

The intermediate portion 3 includes four layers in the Z direction. Carbon fibers 13 are included in each of these layers. Directions of the carbon fibers are 0 degrees, 90 degrees, 90 degrees, and 0 degrees in this order from bottom to top. In the intermediate portion 3, the carbon fibers 13 have a biaxial orientation. FIG. 2B illustrates the intermediate portion 3 and the first skin 1 detached from the intermediate portion 3. As illustrated in FIG. 2B, the X direction corresponds to a longitudinal direction of the carbon fibers 13 in an uppermost layer (i.e., an uppermost area) of the intermediate portion 3. The uppermost layer of the intermediate portion 3 is an outermost layer located closest to the first skin 1. As previously mentioned, the corrugated cross-sectional shape of the intermediate portion 3 is extended in the Y direction. The carbon fibers 13 whose longitudinal direction corresponds to the X direction are substantially orthogonal to the extension direction of the corrugated cross-sectional shape (i.e., the Y direction). Because these carbon fibers 13 oriented at 0 degrees are included in corrugated areas (i.e., the recesses and the protrusions), the panel 100 is able to exhibit high rigidity to withstand a compressive force applied thereto from outside. The content of the carbon fibers 13 in the intermediate portion 3 is also 60 percent by mass. The content of the carbon fibers 13 in the intermediate portion 3, however, may be suitably changed, for example, in the range of between 40 percent by mass and 70 percent by mass, and is particularly preferably in the range of between 55 percent by mass and 70 percent by mass.

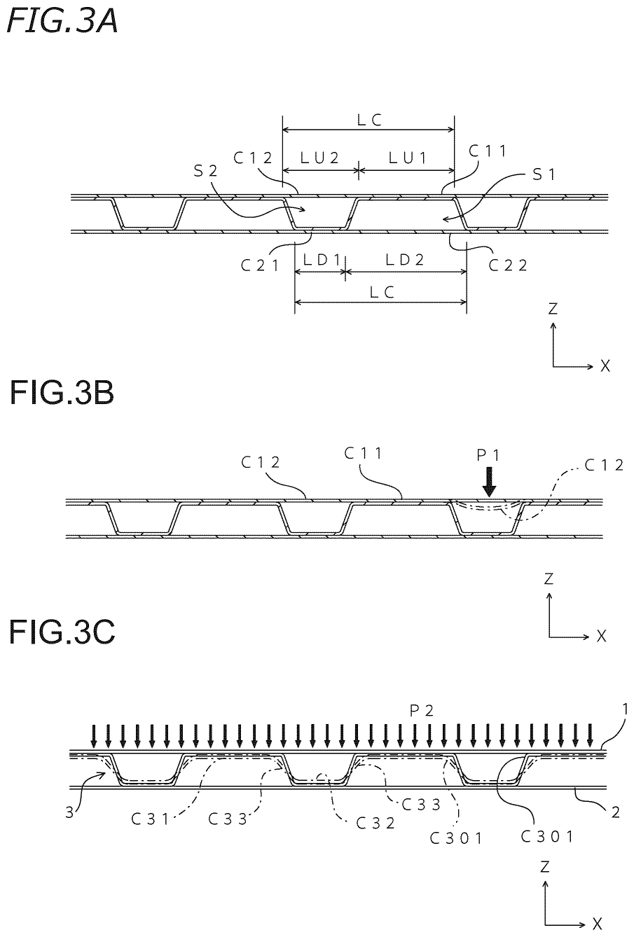

As illustrated in FIG. 3A, within each pitch LC of the corrugated shape (i.e., a length of each pair of the recess and the protrusion in the X direction), LU1>LU2 in the first skin 1, and LD1<LD2 in the second skin 2. LU1>LD1 for the connection regions C11 and C21, and LU2<LD2 for the non-connection regions C12 and C22. Within each pitch LC, not only right and left sides of the corrugated shape but also upper and lower sides of the corrugated shape are asymmetrical on an X-Z plane. Such a shape for each pitch LC of the intermediate portion 3 is repeated continuously in the X direction. A hollow portion defined by each protrusion of the intermediate portion 3 will be referred to as a “mountain-shaped hollow portion S1”, and a hollow portion defined by each recess of the intermediate portion 3 will be referred to as a “valley-shaped hollow portion S2”. The length LU1 of each connection region C11 is longer than the length LU2 of each non-connection region C12, with the result that each mountain-shaped hollow portion S1 is larger than each valley-shaped hollow portion S2. Because the length LU1 of each connection region C11 is relatively long, the number of pitches of the corrugated shape is small. This makes it possible to reduce the required volume of the intermediate portion 3, enabling a reduction in the weight of the panel 100. The panel 100 according to the present example embodiment, in particular, is used as cabin flooring in airplanes. Accordingly, effects achieved as a result of weight reduction mentioned above are significant in view of the number and size of panels 100 to be used.

The panel 100 according to the present example embodiment, whose first skin 1 serves as the upper skin, may be under a local load, examples of which include a load P1 applied to the non-connection region C12 of the first skin 1 by a high-heeled shoe or a falling object as illustrated in FIG. 3B. Because each non-connection region C12 is smaller than each connection region C11, the present example embodiment is able to reduce the degree of deflection of the first skin 1 (see the alternate long and short dash lines) when such a local load is applied thereto. In the first skin 1, a proportion occupied by the connection regions C11 is larger than a proportion occupied by the non-connection regions C12. This makes it possible to reduce the possibility of application of the load P1 to the non-connection regions C12. In the first skin 1, the carbon fibers in the uppermost layer extend in the X direction. Accordingly, the carbon fibers in the uppermost layer are able to reduce the degree of deflection and enhance durability to withstand an impact load. The first skin 1 has the four-layer structure and is thus larger in thickness and stronger in biaxial orientation than the second skin 2 having the three-layer structure. Consequently, the first skin 1 according to the present example embodiment, which serves as the upper skin, has a desired level or higher level of strength to withstand, for example, an impact from above.

The panel 100 according to the present example embodiment also has high durability to withstand out-of-plane compression. As illustrated in FIG. 3C, when a pressure P2 is applied to the first skin 1 from above, the intermediate portion 3 receives the pressure P2 through the first skin 1. The intermediate portion 3 deforms as indicated by the alternate long and short dash lines, with the result that the panel 100 enters a compressed state in the Z direction. The intermediate portion 3, however, has the four-layer structure and includes the biaxially oriented carbon fibers, with the result that the panel 100 would be able to exhibit high durability if the panel 100 is in the compressed state. In the uppermost layer of the intermediate portion 3 located closest to the first skin 1, the carbon fibers 13 are oriented at 0 degrees (see FIG. 2B). This also enables the panel 100 to exhibit high durability. The intermediate portion 3 includes the carbon fibers in its uppermost layer and thus reinforces corner portions C301 (or specifically, areas that change from areas connected to the first skin 1 to areas (i.e., non-connection areas) not connected to the first skin 1). This facilitates maintaining a shape of the first skin 1 and thus facilitates maintaining a shape of an entirety of the panel 100. The present example embodiment provides high strength to withstand out-of-plane compression mentioned above.

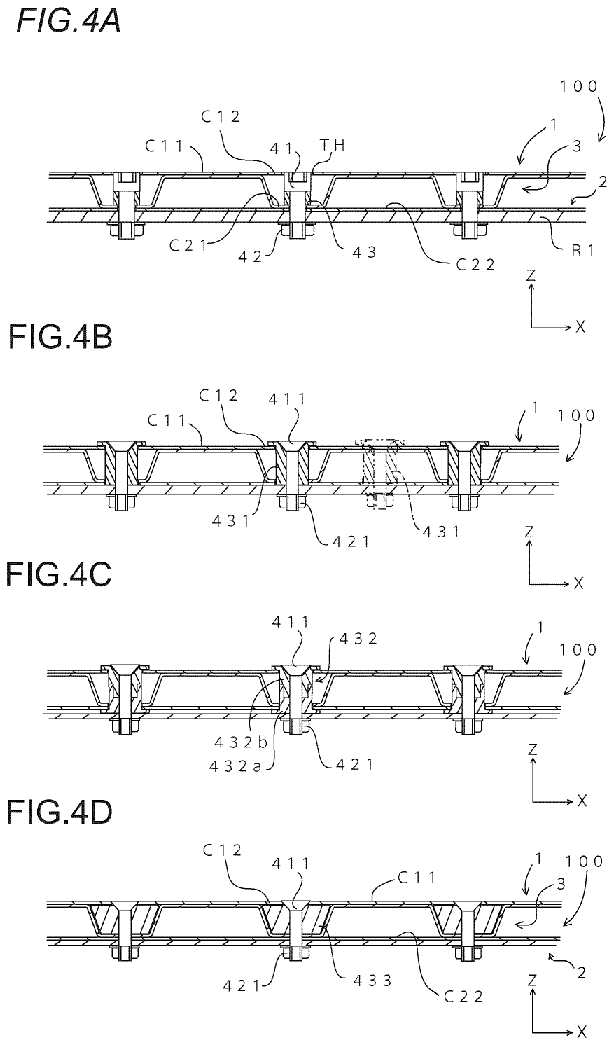

Referring to FIGS. 4A to 4D, the following description discusses how the panel 100 is supported by the supporting rails R1 and R2 each made of metal. FIGS. 4A to 4D provide schematic cross-sectional views each taken along an X-Z plane similarly to FIGS. 3A to 3C.

As illustrated in FIG. 4A, the panel 100 is secured to the supporting rail R1 with bolts 41 and nuts 42. The panel 100 is similarly secured to the supporting rail R2. Shaft portions of the bolts 41 are provided with spacers 43. The non-connection regions C12 of the first skin 1 are provided with through holes TH for the bolts 41 and the spacers 43. The second skin 2, the intermediate portion 3, and the supporting rail R1 are also provided with through holes at positions corresponding to the through holes TH (or specifically, positions vertically under the through holes TH). The bolts 41, which are inserted into these through holes, and the nuts 42 function as fasteners to fasten the panel 100 to the supporting rail R1. In the present example embodiment, the spacers 43 make heads of the bolts 41 flush with the first skin 1. The heads of the bolts 41 do not project from the first skin 1. Accordingly, the panel 100 provides a flat floor surface with no irregularities when used as flooring.

Areas of the panel 100 located under the non-connection regions C12 are two-layer structure areas including the connection regions C21 of the second skin 2, and regions of the intermediate portion 3 connected to the connection regions C21. The bolts 41 are fastened to the non-connection regions C12 of the first skin 1. Thus, fastening forces for the bolts 41 and the nuts 42 are exerted on the supporting rail R1 and the two-layer structure areas provided by the second skin 2 and the intermediate portion 3. The fastening forces for the bolts 41, which are exerted on the two-layer structure areas, include, for example, forces resulting from stress produced in each of the two-layer structure areas and transmitted in a planar direction through the bolts 41. With the fastening forces, the panel 100 is secured to the supporting rail R1. If the bolts 41 are fastened to the connection regions C11 of the first skin 1, the fastening forces for the bolts 41 and the nuts 42 will be exerted on single-layer structure areas provided by the non-connection regions C22 of the second skin 2. Unlike this arrangement, the present example embodiment involves causing the fastening forces for the bolts 41 and the nuts 42 to be exerted on the two-layer structure areas, resulting in increases in the fastening forces. The bolts 41, the nuts 42, the spacers 43, and the through holes TH, for example, are provided at more than one location as illustrated in FIG. 4A. These components are provided at predetermined intervals not only in a right-left direction (i.e., the X direction) but also in a depth direction (i.e., the Y direction) in FIG. 4A. This makes it possible to achieve a high fastening force at each location and thus makes it possible to reduce the numbers of bolts 41 and nuts 42 to be used for the entirety of the panel 100. Positions at which the bolts 41 and the nuts 42 are to be provided, however, are not limited to the illustrated positions. The bolts 41 may be fastened to the connection regions C11 of the first skin 1 (see the chain double-dashed lines in FIG. 4B). The bolts 41 may each be fastened to an associated one of the connection regions C11 and the non-connection regions C12. The bolts 41 do not necessarily have to be provided at substantially central portions of the non-connection regions C12 as illustrated in FIG. 4A. The same goes for the connection regions C11. The bolts 41 may be provided in the connectors C33.

Other structures or methods may be used as fasteners to fasten the panel 100 to the supporting rails R1 and R2. Structures or methods illustrated, for example, in FIGS. 4B, 4C, or 4D may be used as the fasteners.

FIG. 4B illustrates an arrangement that involves using inserts 431 instead of the spacers 43. Bolts 411 and nuts 421 used in this arrangement serve as fasteners to fasten the panel 100 to the supporting rail R1 together with the inserts 431. The bolts 411 are in engagement with the inserts 431. As illustrated in FIG. 4B, the inserts 431 are in engagement with each of the first skin 1, the second skin 2, and the intermediate portion 3. The inserts 431 are provided in the non-connection regions C12 of the first skin 1. In the arrangement that involves using the inserts 431, fastening forces to secure the panel 100 to the supporting rail R1 are generated by stress produced in the two-layer structure areas provided by the intermediate portion 3 and the connection regions C21 of the second skin 2, and stress produced in the non-connection regions C12 of the first skin 1. The inserts 431 may be provided, for example, in the connection regions C11 instead of being provided in the non-connection regions C12 of the first skin 1. In this case, fastening forces are generated by stress produced in two-layer structure areas provided by the intermediate portion 3 and the connection regions C11 of the first skin 1, and stress produced in the non-connection regions C22 of the second skin 2. The fastening forces in this case are thus equivalent in magnitude to the fastening forces generated when the inserts 431 are provided in the non-connection regions C12 of the first skin 1. If the bolts 411, the nuts 421, and the inserts 431 are provided in either the non-connection regions C12 or the connection regions C11 of the first skin 1, similar effects would be achievable. Alternatively, these components may be provided in each of the regions C11 and C12.

As illustrated in FIG. 4C, inserts 432 each including a unitized body structure including sub-portions assembled to each other in a vertical direction (i.e., the Z direction) may be used instead of the inserts 431. The inserts 432 including the sub-portions assembled to each other in this manner may be used when unitized body structures are more preferable than the inserts 431, which are illustrated in FIG. 4B, depending on applications. This arrangement is also able to prevent heads of the inserts 432 and the bolts 411 from projecting from the first skin 1.

Other than structures including the inserts 431 or the inserts 432, structures including cores 433 as illustrated in FIG. 4D may be utilized as the fasteners that involves using the bolts 411 and the nuts 421 described above. In this case, the heads of the bolts 411 are allowed to be substantially flush with the first skin 1 similarly to FIG. 4A. The structures including the cores 433 may involve inserting bolts, each having its head located on the lower side, into the cores 433 from the second skin 2 (i.e., from below in the vertical direction) instead of providing through holes in the first skin 1. In this case, the use of the bolts securable at positions that do not reach the first skin 1 makes it possible to allow the bolts to be substantially flush with a surface (i.e., an upper surface) of the first skin 1. Because the cores 433 are fastened to the bolts 411, the cores 433 in the above-described example are disposed within spaces defined between the non-connection regions C12 of the first skin 1 and the intermediate portion 3. When the bolts 411 are provided in the connection regions C11 (see, for example, positions indicated by the chain double-dashed lines in FIG. 4B), however, the cores 433 may be disposed within spaces defined between the non-connection regions C22 of the second skin 2 and the intermediate portion 3.

The panel 100 according to the present example embodiment has the above-described structure including thermoplastic resin and carbon fibers and is thus impact-resistant. Because the number of pitches of the intermediate portion 3 is reduced, weight reduction is achievable. To enhance durability to withstand a compression load, the intermediate portion 3 having a corrugated shape includes layers each including carbon fibers in the form of continuous fibers. In the layers, the carbon fibers are at least biaxially orientated to substantially perpendicularly intersect a longitudinal direction of the corrugated shape. Because an uppermost one of the layers includes the carbon fibers oriented to substantially perpendicularly intersect the longitudinal direction of the corrugated shape, durability to withstand the compression load (i.e., out-of-plane compression) is remarkably high. In addition, skillfully combining the orientations of the carbon fibers in the layers as previously described makes it possible to increase the bending strength of the panel 100. Similarly, each of the first skin 1 and the second skin 2 also includes layers including at least biaxially oriented carbon fibers and is thus able to have enhanced bending strength. A longitudinal direction of the carbon fibers in an uppermost one of the layers of the first skin 1, which is susceptible to an impact (or in particular, susceptible to a local impact), substantially perpendicularly intersects the longitudinal direction of the corrugated shape. This makes it possible to achieve high durability to withstand an impact. When the panel 100 is used for a purpose that is likely to make the second skin 2 susceptible to an impact such as one mentioned above, the corrugated shape of the intermediate portion 3 and/or the arrangement of the carbon fiber-including layers in each of the first skin 1, the second skin 2, and the intermediate portion 3, for example, may be turned upside down or may be changed suitably in accordance with the purpose of use.

### Second Example Embodiment of Panel

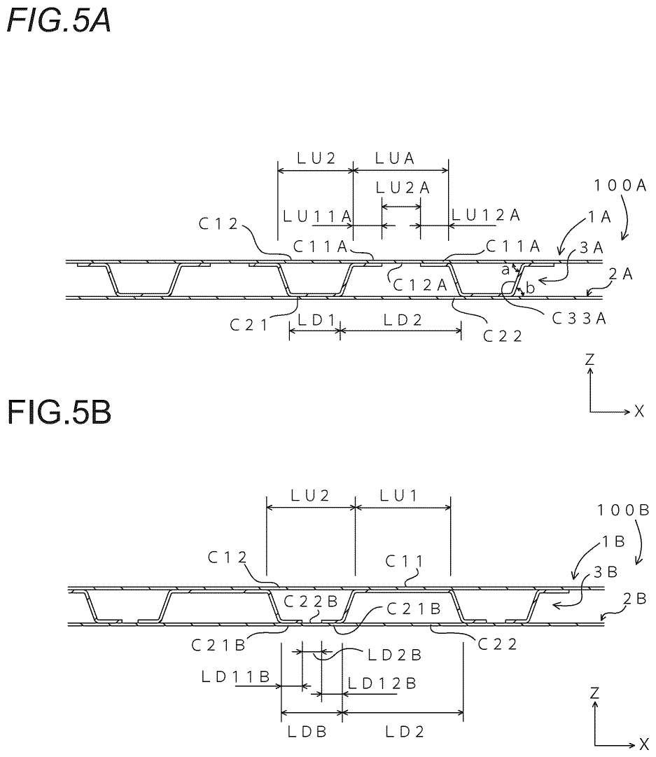

FIG. 5A schematically illustrates a cross-sectional shape of a panel 100 according to a second example embodiment. In the panel 100A according to the present example embodiment, an intermediate portion 3A is hat-shaped. The intermediate portion 3A includes sub-portions arranged in an X direction. These sub-portions are located away from each other in the X direction. The sub-portions each have a hat-like cross-sectional shape orthogonal to a Y direction. A first skin 1A is provided with non-connection regions C12A each located between an associated pair of connection regions C11A. The pairs of connection regions C11A and the non-connection regions C12A face non-connection regions C22 of a second skin 2. In the first skin 1A, the pairs of connection regions C11A and the non-connection regions C12A are arranged alternately with non-connection regions C12 in the X direction. In the second skin 2A, connection regions C21 connected to the intermediate portion 3A are arranged alternately with the non-connection regions C22 in the X direction. A length LU2 and a length LU2A of the first skin 1A are each different from a length LD2 of the second skin 2A.

In the present example embodiment, the first skin 1A is provided with two types of non-connection regions, i.e., the non-connection regions C12 and C12A. The non-connection regions C12 face the connection regions C21 of the second skin 2A. The length LU2 of each non-connection region C12 is substantially equal to the length LU2 (see FIG. 1B) of each non-connection region C12 described in the first example embodiment. The length LU2A of each non-connection region C12A is shorter than the length LU2 of each non-connection region C12. Although lengths LU11A and LU12A of left and right ones of the connection regions C11A adjacent to each non-connection region C12A are equal to each other in this example embodiment, the lengths LU11A and LU12A may be different from each other.

A length LD1 of each connection region C21 and the length LD2 of each non-connection region C22 in the second skin 2A are respectively substantially equal to the lengths LD1 and LD2 described in the first example embodiment. Inclination angles a and b of connectors C33A of the intermediate portion 3A with respect to the first skin 1A and the second skin 2A are also respectively substantially equal to the inclination angles a and b described in the first example embodiment.

Also in the panel 100A, LU2<LD2. Assuming that the sum of the length of each non-connection region C12A and the lengths of the connection regions C11A adjacent thereto in the first skin 1A is represented as LUA (=LU11A+LU2A+LU12A), LUA>LD1. The panel 100A according to the present example embodiment is also able to achieve weight reduction and maintain bending strength at a high level. The panel 100A includes a carbon fiber-including structure similar to that described in the first example embodiment and is thus able to exhibit high durability to withstand an impact from outside while maintaining its bending strength at a high level.

### Third Example Embodiment of Panel

In the panel 100A according to the second example embodiment, the first skin 1A includes two types of non-connection regions, i.e., the non-connection regions C12 and C12A. In a panel 100B according to a third example embodiment, which is illustrated in FIG. 5B, a second skin 2B includes two types of non-connection regions, i.e., non-connection regions C22 and C22B. In the third example embodiment, an intermediate portion 3B has a hat-like cross-sectional shape obtained by turning the hat-like cross-sectional shape described in the second example embodiment upside down.

Also in the present example embodiment, LU2<LD2. Assuming that the sum of a length of each non-connection region C22B and lengths of connection regions C21B adjacent thereto in the second skin 2B is represented as LDB (=LD11B+LD2B+LD12B), LDB<LU1. The panel 100B according to the present example embodiment is also able to achieve weight reduction and maintain bending strength at a high level. The panel 100B includes a carbon fiber-including structure similar to that described in the first example embodiment and is thus able to exhibit high durability to withstand an impact from outside while maintaining its bending strength at a high level.

When a first skin 1B is an upper skin, a proportion occupied by connection regions C11 in the first skin 1B is preferably large. The panel 100B according to the third example embodiment is preferable because the proportion occupied by the connection regions C11 is larger than in the panel 100A according to the second example embodiment. The present example embodiment is able to increase the length LU1 of each connection region C11 in the first skin 1B so as to enhance durability to withstand an impact applied to the first skin 1B. Besides, an arrangement may be made such that a non-connection region is provided in an intermediate area of each connection region C11 (e.g., such that a connection region C11A, a non-connection region C12A, and another connection region C11A are located side by side in this order as illustrated in FIG. 5A), while the above-described various effects are maintainable.

### Fourth Example Embodiment of Panel

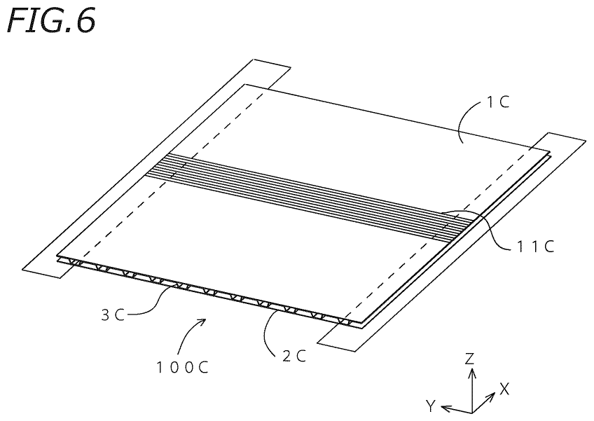

In the first to third example embodiments, longitudinal directions of connection regions and non-connection regions in the intermediate portions 3, 3A, and 3B correspond to the Y direction (see FIG. 1A), and the intermediate portions 3, 3A, and 3B each include the carbon fiber-including layers. FIG. 6 illustrates a panel 100C according to a fourth example embodiment.

In the panel 100C according to the present example embodiment, longitudinal directions of connection regions and non-connection regions in an intermediate portion 3C correspond to an X direction. In each of a first skin 1C and a second skin 2C, connection regions and non-connection regions are arranged alternately in a Y direction. A length of each non-connection region of the first skin 1C in the Y direction and a length of each non-connection region of the second skin 2C in the Y direction are different from each other. Accordingly, similarly to the other example embodiments, the present example embodiment is able to provide high bending strength in a certain direction and high durability to withstand an external impact while achieving weight reduction.

In the panel 100C, carbon fibers 11C are oriented to extend in the Y direction in an uppermost layer of the first skin 1C as illustrated in FIG. 6. As previously mentioned, the first skin 1C includes biaxially oriented layers and thus has predetermined durability to withstand an external impact. The same applies to the second skin 2C and the intermediate portion 3C. Orientations of the carbon fibers, for example, may be changed in accordance with desired bending strength and/or impact durability. When the various fasteners (see FIGS. 4A to 4D) described in the first example embodiment are to be used, the fasteners may be arranged in the X direction. When intervals between the fasteners are not regular intervals but irregular intervals or decided suitably in accordance with design and/or assembly constraints, for example, the present example embodiment, which involves making the longitudinal directions of the connection regions and non-connection regions in the intermediate portion 3C correspond to the X direction, is preferable because the present example embodiment offers a high degree of flexibility in positioning of the fasteners.

### Alternative Example Embodiment of Panel

Although the panels 100, 100A, 100B, and 100C according to the example embodiments have been described thus far, the type of thermoplastic resin included in the first and second skins is not limited to any particular type. Polyphenylene sulfide, ketonic resin, or other resin, for example, may be used. Mainly using a material having a high melting point makes it possible to provide high-strength resin. Alternatively, any material other than these materials may be used. The same type of thermoplastic resin may be used in an intermediate portion.

As the above-mentioned carbon fibers, not only PAN carbon fibers but also PITCH carbon fibers, for example, are used. The continuous fibers, however, are not limited to carbon fibers but may be, for example, glass fibers (e.g., E glass fibers). The term “correspond” as used in the following phrase “the longitudinal direction of the continuous fibers corresponds to the X direction and the Y direction” subsumes not only a strict correspondence with the X direction and the Y direction but also a slight deviation from the X direction and the Y direction. This is because if the longitudinal direction of the continuous fibers is slightly deviated from the X direction and the Y direction, effects similar to those described above would be achievable.

In the foregoing example embodiments, the skins 1 and 2 and the intermediate portion 3 each have a multilayer structure in which the layers including the carbon fibers 11 or 13 are stacked on top of another. The number of layers to be stacked may be changed suitably. The orientations of the carbon fibers are not limited to a biaxial orientation.

Thermoplastic resin and continuous fibers to be included in the first skin, the second skin, and the intermediate portion, which are included in each panel, may be different for each of the structures or may be used in any suitable combination. In the foregoing example embodiments, the first skin and the intermediate portion are welded to each other, and the second skin and the intermediate portion are welded to each other in each panel that includes thermoplastic resin. The foregoing example embodiments are thus characterized as being able to provide these structural elements by using similar types of materials. This enables enhanced recyclability and a shorter manufacturing lead time. As similar types of materials (or identical materials) are used as described above, the above-described effects will be enhanced accordingly.

The panels 100, 100A, 100B, and 100C according to the foregoing example embodiments may be used as portions (e.g., central and/or end portions) of cabin flooring in airplanes. The panels according to example embodiments of the present invention are naturally not limited to flooring or to components to be provided in cabins but may also be used for other portions, such as bodies of cargo compartments. The panels according to example embodiments of the present invention are able to achieve the above-described various effects and thus do not necessarily have to be used for airplanes. The panels according to example embodiments of the present invention may be used in various forms, examples of which include other transporting machines, buildings or structures that require predetermined strength, and conveyed objects that are preferably light in weight.

When a thermoplastic resin-including panel such as one described above is to be manufactured, skillfully combining step(s) for a heating process and step(s) for a skin and intermediate portion connecting process, which are included in manufacturing processes for the panel, exerts a great influence in terms of quality of the resulting panel. The heating process is performed on the basis of melting points of skins and an intermediate portion. Upon completion of the heating process, the skins and the intermediate portion dissipate heat. If a transition is not made from the heating process to the connecting process with a suitable timing or if such a transition is not made promptly, the temperature(s) of the skins and/or the intermediate portion fall(s) well below the melting point(s), which may lead to a failure, such as a connection failure. It is desirable to not only simply increase the magnitude of connection strength but also eliminate any imbalance in the strength. A panel provided with vacant regions arranged side by side, in particular, will face difficulty in having desired bending strength if pressing force is concentrated only on connection region(s).

After the heating process, a cooling process is required. Although manufacturing operations need to be performed speedily, an insufficient temperature drop and/or local residual heat, for example, may lead to a decrease in product quality. A panel manufactured by connecting an intermediate portion to skins such that vacant regions are provided, in particular, is expected to be enhanced in mechanical strength and light in weight. To achieve these goals, sufficient connection strength is not enough, but detailed consideration has to be given to shapes and properties of the skins and the intermediate portion by which the vacant regions are to be formed. These points need to be taken into consideration until the cooling process is finished. This is because a panel including thermoplastic resin, which is easily subjected to secondary forming, will suffer an adverse effect on final quality if a sudden temperature change occurs.

These manufacturing processes offer high versatility in manufacture of panels to be used for various purposes or various types of panels. Importance is placed on proper use of method(s) for minutely controlling environmental conditions, such as temperatures and humidities, and/or process times depending on the purpose of use of panels and/or the types of panels. Accordingly, what are desired are manufacturing methods and manufacturing apparatuses that are able to successfully manufacture panels by skillfully combining the process steps.

### First Example Embodiment of Panel Manufacturing Method and Manufacturing Apparatus

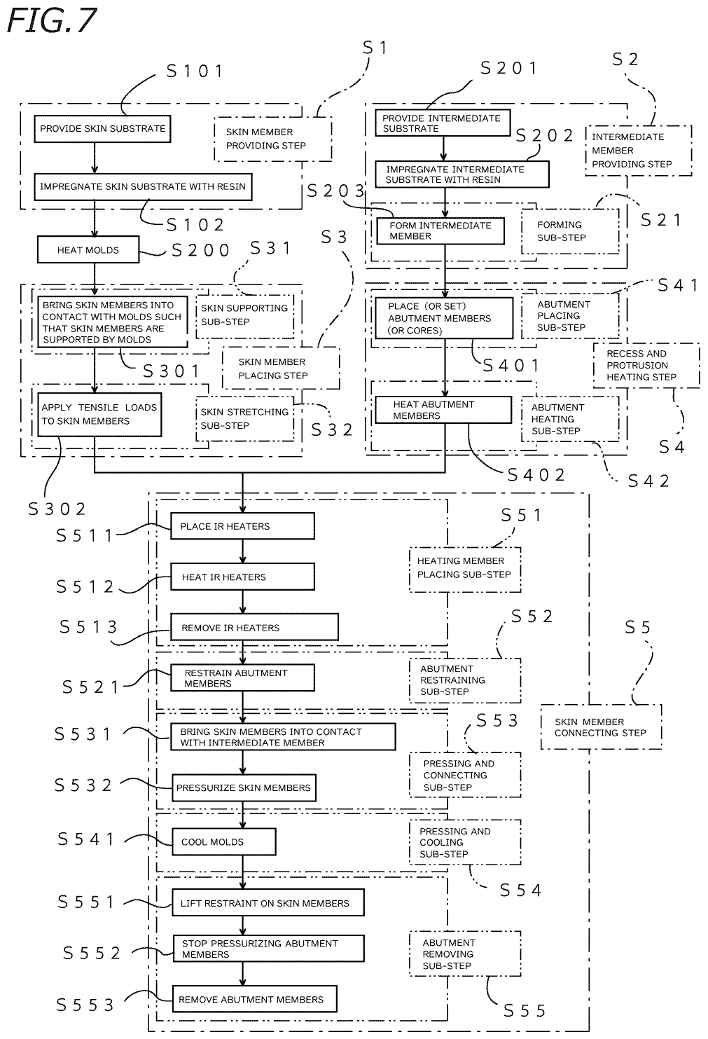

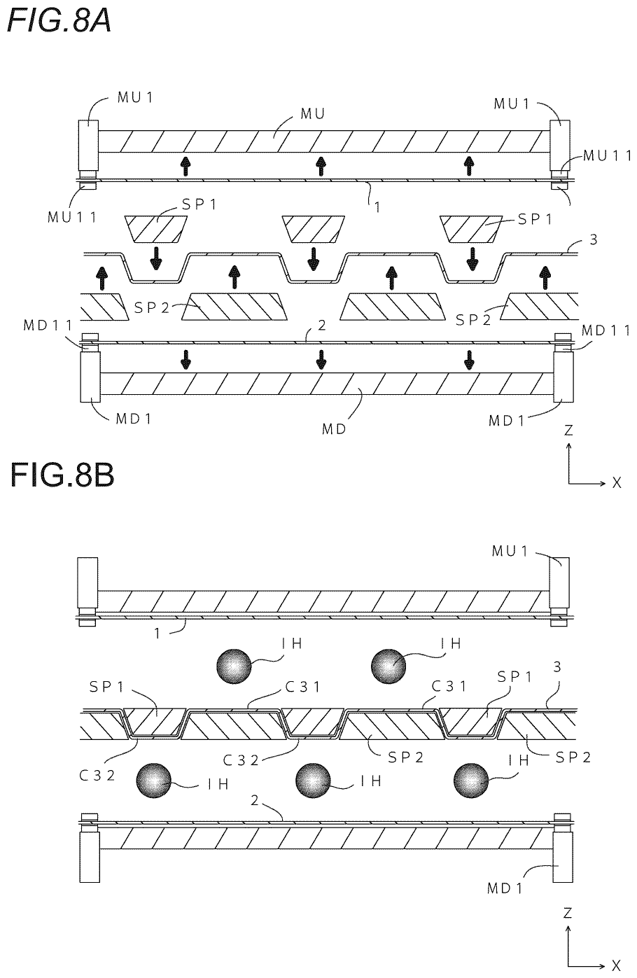

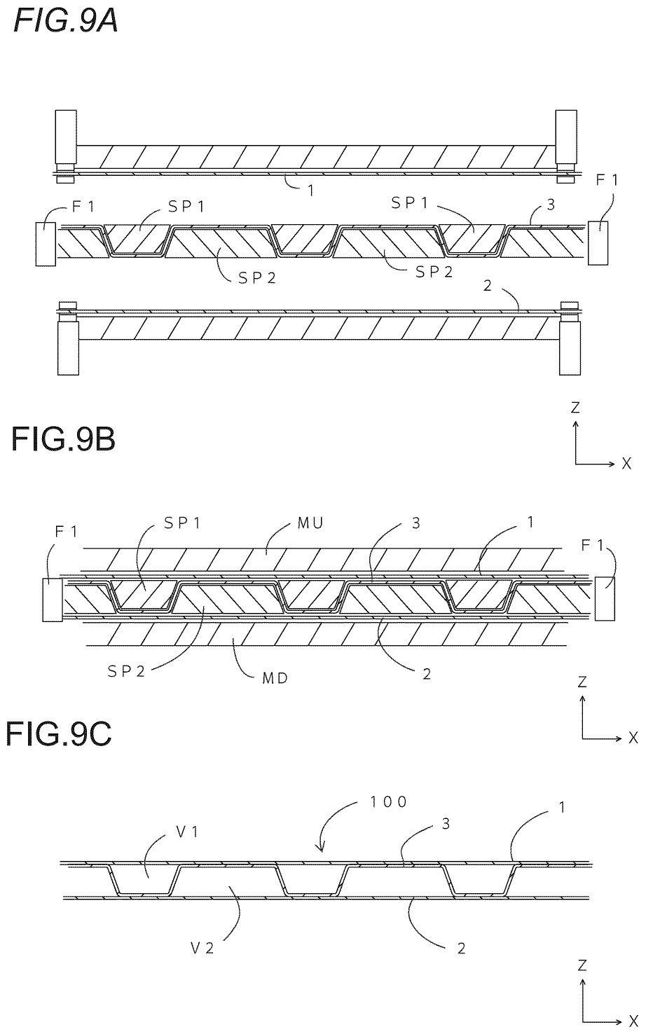

Example embodiments of methods and apparatuses for manufacturing the panel 100 will be described below. In the present example embodiment, an apparatus that combines processing devices for use in steps included in a manufacturing method described below is used as a manufacturing apparatus for the panel 100. FIG. 7 illustrates a flow chart of the steps included in the manufacturing method. FIGS. 8 and 9 provide schematic cross-sectional views illustrating how some of the steps are to be performed.

The manufacturing method according to the present example embodiment includes a skin providing step S1 for providing a first skin 1 and a second skin 2 that are yet to be connected to an intermediate portion 3, an intermediate portion providing step S2 for providing the intermediate portion 3 that is yet to be connected to the first skin 1 and the second skin 2, a skin placing step S3 that is a preparatory operation for connection of the first skin 1 and the second skin 2 to the intermediate portion 3, a recess and protrusion heating step S4 for heating recesses and protrusions of the intermediate portion 3 having a corrugated shape, and a skin connecting step S5 for connecting the intermediate portion 3 to the first skin 1 and the second skin 2 after the skin placing step S3 and the recess and protrusion heating step S4.

The skin providing step S1 involves providing the above-mentioned first and second skin 1 and 2 each having a sheet shape. The step S1 first involves fabricating a first skin substrate provided with four layers of carbon fibers 11 (S101). The step S1 then involves impregnating spaces defined between the carbon fibers 11 of the first skin substrate with thermoplastic resin (S102). This provides a sheet serving as the first skin 1 and enables the carbon fibers 11 to enter a stable fixed state. Similarly, a second skin substate provided with three layers of the carbon fibers 11 is fabricated for the second skin 2 (S101), and the second skin substrate is impregnated with thermoplastic resin (S102). This provides a sheet serving as the second skin 2 and enables the carbon fibers 11 to enter a stable fixed state.

The intermediate portion providing step S2 involves fabricating an intermediate substrate provided with four layers of carbon fibers 13 (S201) and then involves impregnating spaces defined between the carbon fibers 13 of the intermediate substrate with thermoplastic resin (S202). This provides a sheet including the carbon fibers 13 and enables the carbon fibers 13 to enter a stable fixed state. Subsequently, the sheet is formed into a corrugated shape by using a pressing machine (S203), with the result that the intermediate portion 3 is provided (forming sub-step S21).

After each of the skin substrates and the intermediate substrate has been impregnated with thermoplastic resin as described above, operations for connecting the first skin 1 and the second skin 2 to the intermediate portion 3 are performable. As illustrated in FIG. 8A, an upper mold MU and a lower mold MD are disposed one above the other in order to retain the first skin 1 and the second skin 2. Then, a heating process for each of the upper mold MU and the lower mold MD is started (S200). After the heating process has been started, a transition is made to the skin placing step S3. The skin placing step S3 involves performing a skin supporting sub-step S31 for causing the skins 1 and 2 to be respectively supported by the molds MU and MD, and a skin stretching sub-step S32 for applying a tensile load to each of the skins 1 and 2 in a first direction (which is an X direction in the present example embodiment). The skin supporting sub-step S31 involves supporting the first skin 1 with the upper mold MU, and supporting the second skin 2 with the lower mold MD (S301). In the present example embodiment, the temperatures of the molds MU and MD are prevented from being excessively high at the time of the sub-step S31. The skin stretching sub-step S32 involves applying a tensile load to the first skin 1 in the X direction, and applying a tensile load to the second skin 2 in the X direction (S302).

The upper mold MU is provided with retainers MU1 to retain the first skin 1. The lower mold MD is provided with retainers MD1 to retain the second skin 2. The retainers MU1 include a mechanism to allow supporters MU11 for the first skin 1 to be movable in an up-down direction and a horizontal direction relative to the upper mold MU. The retainers MD1 include a mechanism to allow supporters MD11 for the second skin 2 to be movable in the up-down direction and the horizontal direction relative to the lower mold MD. Thus, in the skin placing step S3, the first skin 1 supported by the retainers MU1 is allowed to approach the heated upper mold MU until the first skin 1 comes into contact therewith, and the second skin 2 supported by the retainers MD1 is allowed to approach the heated lower mold MD until the second skin 2 comes into contact therewith (S301). Accordingly, the first skin 1 is heated by the upper mold MU, and the second skin 2 is heated by the lower mold MD, with the result that the thermoplastic resin in the first skin 1 and the second skin 2 starts melting. The term “contact” as used herein not only refers to being in complete contact with a target, but also refers to being close to and slightly away from a target such that sufficient heat is receivable therefrom.

When the skins 1 and 2 are respectively brought close to the molds MU and MD, the retainers MU1 and MD1 apply tensile loads to the first skin 1 and the second skin 2 in the X direction (S302). This makes it possible to apply predetermined tension to the thermoplastic resin that starts melting and thus successfully maintain the shapes of the skins 1 and 2. The farther the distances of portions of the skins 1 and 2 from the supporters MU11 and MD11, the more likely it is that a melting-induced reduction in rigidity will occur in the portions of the skins 1 and 2. The application of tensile loads, however, makes it possible to prevent or limit the reduction in rigidity. Maintaining the rigidity at a certain level makes it possible to enhance the strength of connection of connection regions C11 and C21 to the intermediate portion 3. Non-connection regions C12 and C22, which will not be connected to the intermediate portion 3, are each allowed to have a desired shape. Accordingly, deformation (e.g., film material breakage, overlapping, or swelling) of the skins 1 and 2 is preventable in the range of vacant regions V1 and V2 (i.e., the range of lengths LU2 and LD2 of the non-connection regions C12 and C22). The regions of the skins 1 and 2 are able to maintain their predetermined lengths and are thus able to keep their desired shapes. Consequently, the application of tensile loads is preferable because it serves to improve the quality of the panel 100.

The intermediate portion 3 is subjected to steps for making the intermediate portion 3 connectable to the skins 1 and 2. The recess and protrusion heating step S4 involves performing an abutment placing sub-step S41 and an abutment heating sub-step S42. The abutment placing sub-step S41 involves placing abutments (or cores) SP1 and SP2 in regions equivalent to the vacant regions V1 and V2, respectively (S401). Recesses and protrusions of the intermediate portion 3 are thus filled with the abutments (or cores) SP1 and SP2. The abutments SP1 have shapes that are able to come into contact with the non-connection regions C12 of the first skin 1, lower surface portions C32 of the intermediate portion 3; and connectors C33 (see FIG. 1B). The abutments SP2 have shapes that are able to come into contact with the non-connection regions C22 of the second skin 2, upper surface portions C31 of the intermediate portion 3, and the connectors C33 (see FIG. 1B). The abutments SP1 and SP2 are metallic structures having shapes extended in a Y direction (see FIG. 1A). The abutments SP1 and SP2 are internally provided with cartridge heaters (not illustrated) extending in the Y direction. The abutments SP1 and SP2 are configured to be substantially uniformly heatable across their entire lengths. The abutment heating sub-step S42 involves heating the abutments SP1 and SP2 (S402) so as to start melting of the thermoplastic resin in the intermediate portion 3. The intermediate portion 3 according to the present example embodiment includes carbon fibers (i.e., continuous fibers) having high thermal conductivity. The carbon fibers are biaxially oriented. If the intermediate portion 3 is heated locally, heat would be transmittable to each region of the intermediate portion 3. In the present example embodiment, however, the abutments SP1 and SP2 are configured to have the above-described shapes and to be substantially uniformly heatable in order to improve overall quality of the intermediate portion 3, including maintaining stable rigidity.

Following the skin placing step S3 and the recess and protrusion heating step S4, a transition is made to the skin connecting step S5. The step S5 includes a heater placing sub-step S51 for heating the skins 1 and 2 and the intermediate portion 3 from between the skins 1 and 2 and the intermediate portion 3, an abutment restraining sub-step S52 for preventing movement and deformation of the abutments SP1 and SP2, a pressing and connecting sub-step S53 for applying pressing force to the skins 1 and 2 so as to bring the skins 1 and 2 into contact with the intermediate portion 3, a pressing and cooling sub-step S54 for providing cooling while applying the pressing force, and an abutment removing sub-step S55 for removing the abutments SP1 and SP2 and/or other structure(s) so as to release the pressing force applied to the intermediate portion 3 and/or other structure(s).

The heater placing sub-step S51 involves placing, as illustrated in FIG. 8B, infrared heaters IH (S511). Specifically, the infrared heaters IH are placed at positions located between the first skin 1 and the intermediate portion 3 and over the upper surface portions C31 of the intermediate portion 3, and at positions located between the second skin 2 and the intermediate portion 3 and under the lower surface portions C32 of the intermediate portion 3. The sub-step S51 subsequently involves starting heating of the infrared heaters IH (S512). As a result of this heating, every region of the skins 1 and 2 and the intermediate portion 3 is heated from both above and below (i.e., from both of positive and negative sides in a Z direction) and is thus substantially uniformly heated. As previously mentioned, the skins 1 and 2 and the intermediate portion 3 are heated in advance by the upper mold MU, the lower mold MD, and the abutments SP1 and SP2. This enables a reduction in the time required for heating by the infrared heaters IH. Also during this process, tensile loads are being applied to the skins 1 and 2 from the above-mentioned supporters MU11 and MD11. When a predetermined temperature or time has been reached, heating of the infrared heaters IH is stopped, and the infrared heaters IH are moved to positions away from between the skins 1 and 2 and the intermediate portion 3 (S513).

Then, a transition is made to the abutment restraining sub-step S52. The abutment restraining sub-step S52 involves placing, as illustrated in FIG. 9A, restraints F1 to restrain the abutments SP1 and SP2, which are arranged in the X direction, from moving in the X direction (S521). A longitudinal direction of the restraints F1 is identical to a longitudinal direction of the abutments SP1 and SP2, and corresponds to the Y direction. The restraints F1 are provided such that the restraints F1 are in contact with the abutments SP1 and SP2 in a continuous manner in the Y direction. This accordingly makes the abutments SP1 and SP2 unable to move in the X direction. The restraints F1 may be in intimate contact with the abutments SP1 and SP2 and fixed so as to be immovable in the X direction. Alternatively, the restraints F1 may be movable in the X direction when necessary so as to apply predetermined stress to the abutments SP1 and SP2 in the X direction.

Following the abutment restraining sub-step S52, a transition is made to the pressing and connecting sub-step S53. The sub-step S53 first involves moving the upper mold MU and the lower mold MD toward the intermediate portion 3 such that the skins 1 and 2 are, as illustrated in FIG. 9B, brought into contact with the intermediate portion 3 (S531). At this point, the restraints F1 continue to restrain the abutments SP1 and SP2, and the retainers MU1 and MD1 continue to apply tensile loads to the skins 1 and 2. While the restraint and the application of tensile loads are continued, the sub-step S53 involves starting pressing the skins 1 and 2 against the intermediate portion 3 with the upper mold MU and the lower mold MD. The skins 1 and 2 are thus connected to the recesses and the protrusions of the intermediate portion 3. Specifically, the upper surface portions C31 and the first skin 1 are thermally welded to each other, and the lower surface portions C32 and the second skin 2 are thermally welded to each other (S532). In this case, control is exercised such that the timing of connecting the first skin 1 and the intermediate portion 3 (i.e., the timing of starting the pressurizing and connecting (or thermal welding) process S532) coincides with the timing of connecting the second skin 2 and the intermediate portion 3. In starting the pressing and connecting sub-step S53, the present example embodiment involves exerting control in accordance with, for example, thermal capacity or capacities and/or shape(s) of the intermediate portion 3 and/or the skins 1 and 2, such that temperature variations between the structures 1, 2 and 3 will not occur. So as to continue the variation-free condition, control for causing the connecting timings to coincide with each other is exercised as described above. This makes it possible to increase the uniformity of temperature conditions between the structures 1, 2, and 3 and further improve the quality of the panel 100. At the time of the pressing and connecting sub-step S53, the infrared heaters IH have already been moved as previously mentioned (S513). Because the temperature reduction of the thermoplastic resin in the skins 1 and 2 and the intermediate portion 3 proceeds, the process is desirably performed within a short period of time. In the present example embodiment, the pressing and connecting sub-step S53 involves continuing to heat the abutments SP1 and SP2 and the molds MU and MD. This accordingly makes it possible to limit the temperature reduction and prevent a reduction in connection (or thermal welding) strength. Because movement of the abutments SP1 and SP2 is restrained by the restraints F1, deformation of the abutments SP1 and SP2 caused by thermal expansion is preventable. Upon receiving pressing force from the upper mold MU and the lower mold MD in the Z direction, the abutments SP1 and SP2 may be subjected to stress in the horizontal direction (i.e., the X direction). Deformation and movement of the abutments SP1 and SP2 caused by this stress, however, are also preventable. Deformation of the intermediate portion 3 is also preventable. Accordingly, the panel 100 having enhanced connection strength is manufacturable. The present example embodiment involves performing the pressing and connecting sub-step S53 after having placed the abutments SP1 and SP2, or in particular, after having placed the abutments SP1 and SP2 conforming to the sizes and shapes of the vacant regions V1 and V2. Consequently, the present example embodiment is able to cause the first skin 1 to be substantially uniformly pressed against the protrusions of the intermediate portion 3 and the abutments SP1, and cause the second skin 2 to be substantially uniformly pressed against the recesses of the intermediate portion 3 and the abutments SP2 (see FIG. 8A).

Subsequently, a transition is made to the pressing and cooling sub-step S54. Although not illustrated, the upper mold MU and the lower mold MD are internally provided with coolant passages through which a coolant flows. The pressing and cooling sub-step S54 involves causing the coolant to flow through the upper mold MU and the lower mold MD so as to cool the upper mold MU and the lower mold MD (S541). As a result of this cooling, the skins 1 and 2 and the intermediate portion 3 are also cooled, with the result that the skins 1 and 2 and the intermediate portion 3 decrease in temperature. The sub-step S54 also involves continuing the restraint imposed on the abutments SP1 and SP2 by the restraints F1, application of tensile loads to the skins 1 and 2 from the retainers MU1 and MD1, and pressing by the upper mold MU and the lower mold MD in the Z direction. As a result of cooling described above, the upper mold MU, the lower mold MD, the skins 1 and 2, or the intermediate portion 3 may shrink. Continuing the restraint, application of tensile loads, and pressing as described above, however, would exert pressure feedback that involves continuing application of a predetermined pressure if such shrinkage has occurred, and would thus make it possible to achieve desired shapes and quality with stability. When the sub-step S54 is executable without being affected by shape change(s) of, for example, the skins 1 and 2 or the intermediate portion 3 resulting from temperature change(s), the application of tensile loads may be stopped in advance.

When the temperatures of the upper mold MU and the lower mold MD have decreased to a predetermined crystallization temperature of the thermoplastic resin in the pressing and cooling sub-step S54, a transition is made to the abutment removing sub-step S55. The sub-step S55 involves stopping the upper mold MU and the lower mold MD from pressurizing (including applying tensile loads to) the skins 1 and 2 (S551), and lifting the restraint imposed by the restraints F1 (S552). Then, the panel 100 that has the skins 1 and 2 connected to the intermediate portion 3 is removed. Because the abutments SP1 and SP2 are still inserted into the panel 100 at this point, a pushing bar is pushed into the panel 100 in the Y direction (see FIG. 1A) so as to remove the abutments SP1 and SP2 (S553). As a result, the vacant regions V1 and V2 are provided successfully as illustrated in FIG. 9C, and the connection regions C11 and C21 are able to provide satisfactory connection strength. As previously mentioned, the present example embodiment, in particular, involves connecting the structures 1, 2, and 3 by applying pressure thereto, with the abutments SP1 and SP2 placed, thus enabling the connection regions C11 and C21 to provide sufficient connection strength and enabling regions other than the connection regions C11 and C21 to be also uniformly pressed. This allows the panel 100 to have a satisfactory strength distribution. The process in the pressing and cooling sub-step S54 is performed so as to enable the above-mentioned pressure feedback. In this case, the abutments SP1 and SP2 have shapes conforming to the desired vacant regions V1 and V2, which contributes to providing the satisfactory strength distribution. The present example embodiment enables the skins 1 and 2 and the intermediate portion 3 to have favorable shapes at sophisticated level. Consequently, the present example embodiment is able to closely connect the connection regions C11 and C21 of the skins 1 and 2 to the intermediate portion 3 and cause the other regions of the skins 1 and 2 to have smooth surface shapes. The present example embodiment is also able to cause corner portions of the recesses and protrusions of the intermediate portion 3 to have suitable shapes.

The panel 100 manufactured as described above is able to have a layered structure that is uniform in, for example, thickness and shape across not only the connection regions C11 and C21 and the non-connection regions C12 and C22 of the skins 1 and 2 but also the regions of the intermediate portion 3, such as the upper surface portions C31, the lower surface portions C32, and the connectors C33. Accordingly, the panel 100 is able to have stable bending strength and durability. The panel 100 according to the present example embodiment, which has a structure configured such that a proportion occupied by the non-connection regions C12 is large, is advantageous in terms of achieving the above-described effects and weight reduction. The direction in which the corrugated cross-sectional shape of the intermediate portion 3 extends corresponds to the Y direction, and the carbon fibers in the uppermost layer of the first skin 1 are oriented to extend in the X direction perpendicular to the Y direction. This makes it possible to reduce the degree of deflection and achieve high durability to withstand an impact load. The first skin 1 has the four-layer structure and is thus larger in thickness and stronger in biaxial orientation than the second skin 2 having the three-layer structure. The first skin 1, which serves as the upper skin, carries out its functions at or above a desired level in terms of, for example, strength to withstand an impact from above.

In the present example embodiment, tensile loads, which have been applied in the skin placing step S3, are applied continuously until the pressing and cooling sub-step S54. This makes it possible to provide stable connection strength between each of the skins 1 and 2 and the intermediate portion 3. Not only the connection regions but also the non-connection regions C12 and C22 are allowed to be stabilized in shape and quality. Accordingly, the panel 100 is able to have high durability to withstand out-of-plane compression. When pressure is applied from above to the first skin 1 serving as the upper skin, the intermediate portion 3 changes in shape substantially uniformly for each pitch LC, with the result that the panel 100 is satisfactorily compressed in the Z direction. Because the intermediate portion 3 has the four-layer structure in which the carbon fibers that are continuous fibers are biaxially oriented as mentioned above, the panel 100 would be able to exhibit high durability if the panel 100 is in the compressed state just described. The carbon fibers 13 in the uppermost layer located close to the first skin 1 are oriented at 0 degrees (see FIG. 2B), which significantly produces the effect of enhancing durability. Because the panel 100 includes the carbon fibers 13 in the uppermost layer, the corner portions of the intermediate portion 3 (or specifically, areas that change from areas connected to the first skin 1 to areas (i.e., non-connection areas) not connected to the first skin 1) are reinforced so as to maintain the shape of the first skin 1. The shape of the entirety of the panel 100 is maintained satisfactorily. This accordingly results in an increase in strength to withstand out-of-plane compression described above.

The manufacturing apparatus according to the present example embodiment is a manufacturing apparatus to carry out the above-described manufacturing method. The manufacturing apparatus according to the present example embodiment includes the upper mold MU, the lower mold MD, the abutments SP1 and SP2, and the restraints F1. Because the manufacturing apparatus includes these structural elements, the manufacturing apparatus is able to appropriately exercise control including the order and control of the manufacturing steps described above. In the present example embodiment, the heating process and the connecting process are performed. The manufacturing apparatus according to the present example embodiment is designed in consideration of influences of heat dissipation and is thus able to ensure operational promptness. The manufacturing apparatus according to the present example embodiment is able to apply appropriate loads not only in the course of each process but also at the times before and after each process. The manufacturing apparatus according to the present example embodiment is preferable because stable product quality is achievable. The manufacturing apparatus is not limited to an integrated configuration but may be configured to be separately arranged in a predetermined space, as long as the manufacturing apparatus is able to perform the above-described method and achieve its effects.

### Second Example Embodiment of Panel Manufacturing Method and Manufacturing Apparatus

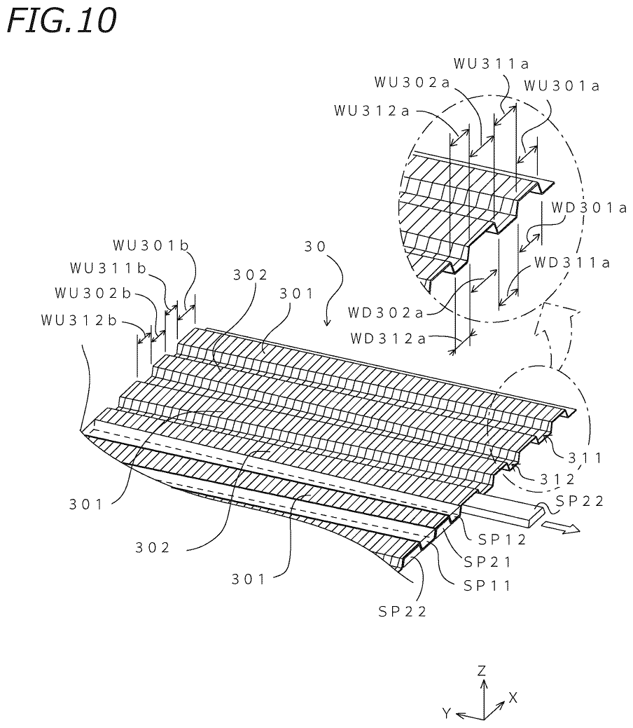

In the foregoing example embodiment, the forming sub-step S21 involves forming the intermediate portion 3 whose uniformly corrugated cross-sectional shape extends in the Y direction. The forming sub-step S21, however, may involve forming the intermediate portion 3 to have a different shape. In one example, an intermediate portion 30 having a shape illustrated in FIG. 10 may be formed.

The intermediate portion 30 also includes recesses and protrusions alternately arranged in an X direction. In the present example embodiment, the recesses and the protrusions each have a shape whose width (i.e., whose length in the X direction) gradually increases or decreases in a Y direction. The intermediate portion 30 according to the present example embodiment includes first protrusions 301 whose widths gradually increase to a positive side in the Y direction; second protrusions 302 whose widths gradually decrease to the positive side in the Y direction, first recesses 311 whose widths gradually decrease to the positive side in the Y direction, and second recesses 312 whose widths gradually increase to the positive side in the Y direction. In the present example embodiment, the forming sub-step S21 involves using a pressing machine to press the intermediate portion 30 into the shape illustrated in FIG. 10.

Focusing now on an upper surface portion of each first protrusion 301, its Y-direction positive side end width WU301b is larger than its Y-direction negative side end width WU301a. Focusing on an opening of each first protrusion 301 as viewed from a negative side in a Z direction (i.e., as viewed from below), its Y-direction positive side end width is larger than its Y-direction negative side end width WD301a. Focusing on an upper surface portion of each second protrusion 302, its Y-direction positive side end width WU302b is smaller than its Y-direction negative side end width WU302a. Focusing on an opening of each second protrusion 302 as viewed from the negative side in the Z direction, its Y-direction positive side end width is smaller than its Y-direction negative side end width WD302a. Focusing on an opening of each first recess 311 as viewed from a positive side in the Z direction (i.e., as viewed from above), its Y-direction positive side end width WU311b is smaller than its Y-direction negative side end width WU311a. Focusing on a lower surface portion of each first recess 311, its Y-direction positive side end width is smaller than its Y-direction negative side end width WD311a. Focusing on each second recess 312 as viewed from the positive side in the Z direction (i.e., as viewed from above), its Y-direction positive side end width WU312b is larger than its Y-direction negative side end width WU312a. Focusing now on a lower surface portion of each second recess 312, its Y-direction positive side end width is larger than its Y-direction negative side end width WD312a.

FIG. 10 illustrates the process of an abutment removing sub-step S55 according to the present example embodiment, with abutments SP11, SP12, SP21, and SP22 remaining in some of the recesses and the protrusions. FIG. 10 illustrates the process of the sub-step S55, which involves sequentially removing the abutments SP11, SP12, SP21, and SP22.

As indicated by the open arrow, the abutments SP22 are pushed out to a negative side in the Y direction from the second protrusions 302 whose widths gradually decrease to the positive side in the Y direction. The abutments SP21 are pushed out to the positive side in the Y direction from the first protrusions 301 whose widths gradually increase to the positive side in the Y direction. The abutments SP12 are pushed out to the positive side in the Y direction from the second recesses 312. The abutments SP11 are pushed out to the negative side in the Y direction from the first recesses 311. When thermoplastic resin is subjected to a heating process and/or a connecting process (including a pressing process) as described above, the surface of each region may be minutely deformed and/or damaged. Providing the shape illustrated in FIG. 10 such that the recesses and the protrusions each gradually increase or gradually decrease in width as in the present example embodiment, however, facilitates pushing out the abutments SP11, SP12, SP21, and SP22.

### Alternative Example Embodiment of Panel Manufacturing Method and Manufacturing Apparatus

When the heating process is successfully performable during the process of heating the upper mold MU and the lower mold MD (S200) and the recess and protrusion heating step S4 in the foregoing example embodiments, the heater placing sub-step S51 may be skipped. Skipping the heater placing sub-step S51 is preferable in terms of, for example, reducing manufacturing time and simplifying the configuration of the manufacturing apparatus. If the heater placing sub-step S51 is skipped, the skin connecting step S5 would involve keeping the abutments SP1, SP2, SP11, SP12, SP21, and SP22 heated, which would make it possible to prevent a temperature reduction until the start of the connecting process and prevent a failure, such as a connection failure. In the foregoing example embodiments, the intermediate portions 3 and 30 each have a corrugated shape. The intermediate portions 3 and 30, however, may each have any shape other than a corrugated shape as long as the intermediate portions 3 and 30 each include recesses and protrusions such that resulting panels are each provided with vacant regions. The corrugated shape of the intermediate portion may be such that LU1<LU2 or LU1=LU2 for each pitch LC or such that LD1>LD2 or LD1=LD2 for each pitch LC.

The structural elements included in the manufacturing apparatus according to the present example embodiment are also not limited to the shapes or materials described above. In the foregoing example embodiments, the abutments SP1, SP2, SP11, SP12, SP21, and SP22, for example, are metallic structures that achieve the above-described operational effects. The abutments, however, may be made of any other material as long as the abutments are thermally conductive. In one example, structural elements low in thermal expansion coefficient and stable in shape and dimension under heated conditions may be usable because such structural elements are able to achieve equivalent effects. When the abutment heating sub-step S42 involves additionally using other heating methods or structures, the abutments SP1, SP2, SP11, SP12, SP21, and SP22 themselves do not necessarily have to have heat conducting functions. In the foregoing example embodiments, the pressing and connecting sub-step S53 involves using structures or methods for bringing the first skin 1 and the second skin 2 close to the intermediate portion 3. The sub-step S53, however, is not limited to the use of such structures or methods. The sub-step S53 may involve using structures or methods for bringing the intermediate portion 3 close to the first skin 1 or the second skin 2. The sub-step S53 may involve using structures or methods for bringing the first skin 1 and the intermediate portion 3 close to each other, and then bringing the first skin 1 and the intermediate portion 3 close to the second skin 2. In the foregoing example embodiments, the pressing and connecting sub-step S53 involves making the timing of connecting the first skin 1 and the intermediate portion 3 (i.e., the timing of starting the pressurizing and connecting process S532) coincide with the timing of connecting the second skin 2 and the intermediate portion 3. The timings, however, may be suitably changed in accordance with, for example, the thermal capacity or capacities of the intermediate portion 3 and/or other structure(s), and/or the shape(s) of the intermediate portion 3 and/or the skins 1 and 2. At the start of the pressing and connecting sub-step S53, for example, control may be exercised so as to create a time lag between the connecting timings such that temperature variations between the structures 1, 2, and 3 are reduced or prevented. This makes it possible to increase the uniformity of temperature conditions between the structures 1, 2, and 3 during manufacturing processes, with the result that the panel 100 of high quality is manufacturable. Timing control for improving the quality of the panel 100 is not limited to controlling connection starting timings (i.e., the connecting timings). The same applies to timing control for starting or ending the abutment removing sub-step S55, which ends the connecting process, and the pressing and cooling sub-step S54, which is related to cooling.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A panel comprising:
a first skin and a second skin each including thermoplastic resin and having a sheet shape; and
an intermediate portion including continuous fibers and interposed between the first skin and the second skin; wherein
the first skin includes a first connection region connected to the intermediate portion, and a first non-connection region not connected to the intermediate portion;
the second skin includes a second connection region connected to the intermediate portion, and a second non-connection region not connected to the intermediate portion;
the first connection region and the first non-connection region are arranged alternately in a first direction;
the second connection region and the second non-connection region are arranged alternately in the first direction;
a dimension of the first non-connection region in the first direction is smaller than a dimension of the second non-connection region in the first direction;
the first skin includes a plurality of layers; and
an outermost layer of the plurality of layers of the first skin includes first skin continuous fibers extending in the first direction, the outermost layer being one of the plurality of layers that is located farthest away from the intermediate portion.

2. The panel according to claim 1, wherein
the first skin is an upper skin above the intermediate portion; and
the second skin is a lower skin below the intermediate portion.

3. The panel according to claim 1, wherein
a dimension of the first connection region in a second direction perpendicular to the first direction is larger than a dimension of the first connection region in the first direction;
a dimension of the first non-connection region in the second direction is larger than the dimension of the first non-connection region in the first direction;
a dimension of the second connection region in the second direction is larger than a dimension of the second connection region in the first direction;
a dimension of the second non-connection region in the second direction is larger than the dimension of the second non-connection region in the first direction; and
the continuous fibers included in the intermediate portion include first intermediate continuous fibers extending in the first direction.

4. The panel according to claim 3, wherein
the continuous fibers included in the intermediate portion further include second intermediate continuous fibers extending in a direction intersecting the first direction; and
the first intermediate continuous fibers are in an area of the intermediate portion between the first skin and the second intermediate continuous fibers and adjacent to the first skin.

5. The panel according to claim 1, wherein
the first skin includes second skin continuous fibers extending in a direction intersecting the first direction;
the first skin continuous fibers are in an area of the first skin located opposite to the intermediate portion; and
the second skin continuous fibers are between the first skin continuous fibers and the intermediate portion.

6. The panel according to claim 1, wherein a cross-sectional shape of the intermediate portion orthogonal to a second direction perpendicular to the first direction is a corrugated shape.

7. The panel according to claim 1, wherein
the intermediate portion includes sub-portions arranged in the first direction and separated from each other in the first direction; and
a cross-sectional shape of each of the sub-portions orthogonal to a second direction perpendicular to the first direction is a hat shape.

8. A panel manufacturing method for manufacturing the panel according to claim 1, wherein
the intermediate portion includes vacant regions defined by recesses and protrusions arranged in the first direction and extending in a second direction perpendicular to the first direction; and
the panel manufacturing method comprises:
a recess and protrusion heating step for performing a heating process on the recesses and the protrusions of the intermediate portion;
a skin placing step for placing the first skin on a first side in a third direction relative to the intermediate portion, and placing the second skin on a second side in the third direction relative to the intermediate portion, the third direction being perpendicular to the first direction and the second direction; and
a skin connecting step for, after the skin placing step, connecting the first skin to the protrusions and connecting the second skin to the recesses.

9. The panel manufacturing method according to claim 8, wherein
the recess and protrusion heating step includes:
an abutment placing sub-step for placing abutments in the vacant regions and bringing the abutments into abutting contact with the intermediate portion; and
an abutment heating sub-step for heating the abutments.

10. The panel manufacturing method according to claim 8, wherein
the skin placing step includes:
a skin supporting sub-step for supporting the first skin with a first support, and a skin stretching sub-step for applying a tensile load to the first skin in the first direction; and/or
a skin supporting sub-step for supporting the second skin with a second support, and a skin stretching sub-step for applying a tensile load to the second skin in the first direction.

11. The panel manufacturing method according to claim 9, wherein the skin connecting step involves continuing to heat the abutments after the abutment heating sub-step.

12. The panel manufacturing method according to claim 9, wherein the skin connecting step includes an abutment restraining sub-step for applying a restraining load to the abutments to prevent expansion of the abutments in the first direction.

13. The panel manufacturing method according to claim 8, further comprising an intermediate portion providing step for providing the intermediate portion; wherein
the intermediate portion providing step includes a forming sub-step for forming the intermediate portion such that either the recesses or the protrusions have shapes with dimensions in the first direction that gradually decrease in the second direction, and others of the recesses and the protrusions have shapes with dimensions in the first direction that gradually increase in the second direction; and
the skin connecting step includes a pressing and cooling sub-step for cooling the first skin, the second skin, and the intermediate portion, and an abutment removing sub-step for removing the abutments from the vacant regions in the second direction.

14. The panel manufacturing method according to claim 8, wherein
the recess and protrusion heating step includes an abutment placing sub-step for placing abutments in the vacant regions and bringing the abutments into abutting contact with the intermediate portion;
the skin connecting step includes a pressing and connecting sub-step for connecting the first skin to the protrusions while pressing the first skin thereto, and connecting the second skin to the recesses while pressing the second skin thereto; and
the pressing and connecting sub-step is performed after the abutment placing sub-step.

15. The panel manufacturing method according to claim 8, wherein
the skin connecting step includes:
a pressing and connecting sub-step including using a press to connect the first skin to the protrusions while pressing the first skin thereto and/or connecting the second skin to the recesses while pressing the second skin thereto; and
a pressing and cooling sub-step for cooling the press.

16. The panel manufacturing method according to claim 15, wherein
the recess and protrusion heating step includes:
an abutment placing sub-step for placing abutments in the vacant regions and bringing the abutments into abutting contact with the intermediate portion; and
an abutment heating sub-step for heating the abutments.

17. The panel manufacturing method according to claim 16, wherein
the skin connecting step includes a heater placing sub-step for placing a heater between the first skin and the intermediate portion to heat the first skin and the intermediate portion with the heater, and/or placing a heater between the second skin and the intermediate portion to heat the second skin and the intermediate portion with the heater.

18. A panel manufacturing apparatus for manufacturing the panel according to claim 1, wherein
the intermediate portion is provided with vacant regions defined by recesses and protrusions arranged in the first direction and extending in a second direction perpendicular to the first direction; and
the panel manufacturing apparatus comprises:
a first mold to place the first skin on a first side in a third direction relative to the intermediate portion and support the first skin such that the first skin is movable toward a second side in the third direction, the third direction being perpendicular to the first direction and the second direction;
a second mold to place the second skin on the second side in the third direction relative to the intermediate portion and support the second skin such that the second skin is movable toward the first side in the third direction;
abutments to be placed in the vacant regions of the intermediate portion and brought into abutting contact with the recesses and the protrusions; and
a restraint to restrain movement of the abutments in the first direction.
